(19) United States
(12) Patent Application Publication
(10) Pub. No.: US 2018/0320413 A1
(43) Pub. Date: Nov. 8, 2018

(54) GEAR SYSTEM FOR DEADBOLT ACTUATION

(71) Applicant: ASSA ABLOY Residential Group, Inc., New Haven, CT (US)

(72) Inventor: Wai P. Wong, Orange, CT (US)

(21) Appl. No.: 15/962,448

(22) Filed: Apr. 25, 2018

Related U.S. Application Data
(60) Provisional application No. 62/552,195, filed on Aug. 30, 2017.
(60) Provisional application No. 62/501,308, filed on May 4, 2017.

(51) Int. Cl. E05B 53/00; F16H 1/46; F16H 35/10; E05B 47/00

(52) U.S. Cl. CPC E05B 53/008; F16H 1/46; F16H 35/10; E05B 47/0012; E05Y 2900/132; E05B 2047/003; E05Y 2201/434; E05Y 2201/42; E05Y 2201/72; E05B 2047/0022

(57) ABSTRACT

A gear system for a deadbolt lock including a planetary gear set. The gear system may include a thumb turn direct-drive system to bypass a motor, and an overload protection system to prevent damage to the motor in the event of a jam.

### RELATED APPLICATIONS

This application claims the benefit of U.S. Provisional Application No. 62/552,195, filed on Aug. 30, 2017, and U.S. Provisional Application No. 62/501,308, filed on May 4, 2017, each of which is incorporated herein in its entirety.

### FIELD

Embodiments disclosed herein are related to motorized door lock deadbolt actuation systems.

### BACKGROUND

Those who wish to secure their homes may add protection such as a deadbolt lock to their doors. In the age of “smart” homes, it may be desirable to have an electromechanical deadbolt that can be activated remotely. It is known in the art to use a gear train to bridge motor output and deadbolt actuation. Existing gear trains result in inefficient output force thereby resulting in the need for oversized motors.

### SUMMARY

In one embodiment, a deadbolt lock assembly includes a gear train including a planetary gear set and a deadbolt operatively coupled to the planetary gear set. Actuation of the planetary gear set drives the planetary gear set to move the deadbolt.

In another embodiment, a deadbolt lock assembly includes a gear train including a planetary gear set. The planetary gear set has a ring gear. A deadbolt is operatively coupled to the planetary gear set. Actuation of the planetary gear set drives the planetary gear set to move the deadbolt. A hand operated drive actuator is operatively coupled to the deadbolt to move the deadbolt between an extended position and a retracted position. A clutch is coupled to the hand operated drive actuator. The clutch is operatively coupled to the ring gear. Turning the hand operated drive actuator causes the clutch to rotate the ring gear, which causes the deadbolt to move.

In another embodiment, a deadbolt lock assembly includes a gear train and a deadbolt operatively coupled to the gear train. A motor is operatively coupled to the gear train. Rotation of the motor causes rotation of the gear train to move the deadbolt. An overload protection arrangement cooperates with the gear train and decouples at least a portion of the gear train from the motor when a resistance to deadbolt movement exceeds a predetermined threshold.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is an exploded perspective view of a lock assembly including a gearbox assembly according to one embodiment;

FIG. 2 is an exploded perspective view of the gearbox assembly of FIG. 1;

FIG. 3 is a cross-sectional view of the gearbox assembly according to one embodiment;

FIG. 4 is an exploded bottom perspective view of a planetary gear system according to one embodiment used in the gearbox assembly;

FIG. 5 is an exploded top perspective view of a planetary gear system according to one embodiment used in the gearbox assembly;

FIG. 6 is an exploded view of the gearbox assembly with a thumb-turn direct drive system;

FIG. 7a is a cross-sectional view of a clutch assembly employed in the gearbox assembly;

FIG. 7b is a perspective view of the clutch assembly of FIG. 7a;

FIG. 7c is a cross-sectional view of the clutch assembly of FIG. 7a in a disengaged state;

FIG. 7d is a schematic view of a portion of the clutch assembly of FIG. 7a, annotated to illustrate its operational range;

FIG. 7e is an enlarged view a ball detent recess in the gear assembly housing;

FIG. 8a is a partial perspective view of an overload protection system in a normal state;

FIG. 8b is a cross-sectional perspective view of the overload protection system of FIG. 8a;

FIG. 8c is a cross-sectional perspective view of the overload protection system in an activated state.

FIG. 9 is an exploded perspective view of another embodiment of a gearbox assembly;

FIG. 10 is an exploded perspective view of a planetary gear system according to another embodiment used in the gearbox assembly;

FIG. 11 is an exploded view of the gearbox assembly of FIG. 9 with a thumb-turn direct drive system;

FIG. 12 is a bottom view of the cap part of the planetary gear system of FIG. 10;

FIG. 13 is a perspective view of a clutch disk and a second stage carrier of the planetary gear system of FIG. 10;

FIG. 14a is a cross-sectional view of a clutch assembly employed in the gearbox assembly of FIG. 9 during a thumb-turn operation;

FIG. 14b is cross-sectional view of a clutch assembly employed in the gearbox assembly of FIG. 9 during motor operations;

FIG. 14c is a side view of the clutch assembly of the gearbox assembly of FIG. 9;

FIG. 15a is a cross-sectional view of the overload protection system of the gearbox assembly of FIG. 9 in its normal state; and

FIG. 15b is a cross-sectional view of the overload protection system of the gearbox assembly of FIG. 9 in an overloaded state.

### DETAILED DESCRIPTION

It should be understood that aspects are described herein with reference to certain illustrative embodiments and the figures. The illustrative embodiments described herein are not necessarily intended to show all aspects, but rather are used to describe a few illustrative embodiments. Thus, aspects are not intended to be construed narrowly in view of the illustrative embodiments. In addition, it should be understood that certain features disclosed herein may be used alone or in any suitable combination with other features.

A deadbolt lock is a common locking arrangement used to secure doors. As well known in the art, a deadbolt lock includes a bolt that, in an open or retracted position, sits at least partially within its housing, and in a locked or extended position, extends outward from its housing into a complementary recess within an associated doorframe, thereby preventing the opening of the door it secures. In the age of home automation, it is becoming increasingly common to have a deadbolt system outfitted with a remotely operable electromechanical actuation system to allow a user to operate the deadbolt when not immediately near the door.

In such electromechanically operated deadbolt systems, known mechanisms commonly involve the use of an electric motor to drive the movement of the deadbolt. Most small electric motors suitable for this application deliver high-speed rotational outputs that are not conducive to moving a deadbolt into the extended or retracted positions. Thus, many existing electromechanically driven deadbolt systems employ gear trains to both translate motor rotational output to linear motion, and reduce the delivered speed while increasing output force. Such gear trains often involve multiple stages to progressively reduce the rotational speed and increase the rotational torque in order to move the deadbolt. Due to the nature of such gear systems, eventual shaft outputs tended to be relatively inefficient. Further, such gear trains tended to be relatively large.

In view of the above, the inventors have found that a conventional gear train could be improved. In one embodiment, a planetary gear system is employed to improve output efficiency while limiting spatial requirements. As is understood by those of skill in the art, planetary gear arrangements may be used to convert high speed, low torque inputs to low speed, high torque outputs. A planetary gear system can improve efficiency and occupy less space than an equivalent “linear” gear train. The inventors have implemented an electromechanical deadbolt system utilizing a planetary gear system as detailed in this disclosure. To keep the gear train relatively slim, the motor may be connected to the planetary gear system via a first stage gear train involving a bevel gear which mates with a motor bevel pinion. Other intersecting shaft arrangements are contemplated including, but not limited to, worm gears, cylkro gears, screw gears, miter gears, or any other gear system appropriate for intersecting shaft applications, as the present disclosure is not limited in this respect. The output from the first gear stage is used to drive the planetary gear set. The output of the planetary gear system drives the deadbolt between its open and locked positions.

It is further contemplated that users of a remotely activatable deadbolt system may desire to circumvent the remote features and instead manually lock and unlock the deadbolt. However, if a user hand actuates the gear transmission via a drive bar commonly known in deadbolt and locking art, it could back-drive the associated motor and over time possibly cause significant wear to the system. Further, hand actuating the gear transmission would require multiple turns of the drive bar to retract the deadbolt. Thus, the inventors have found that it would be beneficial to have a system that allows the user to manually actuate the deadbolt without also activating at least portions of the gear train that otherwise back-drive the motor and/or otherwise require multiple revolutions of the thumb drive. Some embodiments of the electromechanical deadbolt with a planetary gear system further includes a clutch that allows disengagement of at least a portion of the gear system connected to the motor. Rotation of the drive bar causes the clutch to simultaneously disengage the gear train and directly trigger the actuator that shifts the deadbolt as will be explained further below. Instead of a drive bar, the user could utilize a knob, or a lever, or any suitable drive actuator that allows the operator to produce rotational motion.

The inventors have further contemplated that if the deadbolt were to become blocked due to physical obstruction or being misaligned with its recess, the gear system could jam and subsequently overload the motor and damage the system. In view of this, in some embodiments, an overload protection system may be employed to protect the motor and gearbox. In this regard, should the deadbolt become stuck, the overload protection system causes portions of the gear train to become disengaged, such that motor rotation is not transmitted to the otherwise stuck deadbolt, thereby preventing damage to the system.

Turning now to the figures, several non-limiting embodiments are described in further detail. It should be understood that the various features and components described in regards to the figures may be arranged in any desired combination and that the current disclosure is not limited to only those embodiments depicted in the figures.

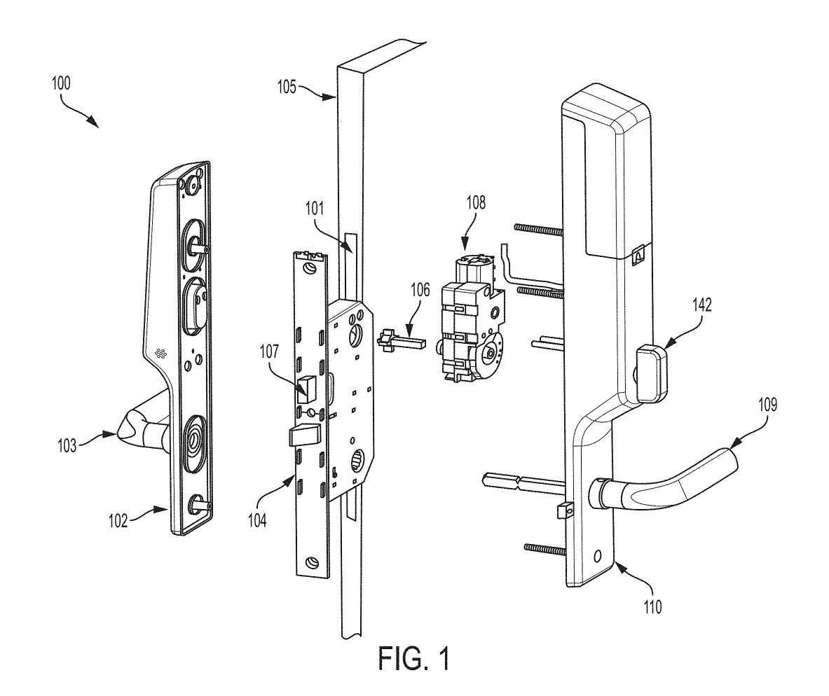

FIG. 1 depicts an exploded view of a possible lock system including an embodiment of the gearbox including the planetary gear system. A lock assembly 100 may be set into a compatible door 105 to provide locking capabilities to the door. A front escutcheon plate 102 protrudes from the door to face the “outside”, and has an outer lever handle 103 connected to a mortise lockset 104, which is set into a recess 101 in the door. Pulling down on the outer lever handle retracts the spring latch integral to the mortise lockset, thus allowing entrance through the door when the door is not locked. A main escutcheon 110 on the other side of the mortise lockset 104 protrudes from the door to face the “inside”. On the main escutcheon 110 is an inner lever handle 109, which functions similarly to the outer lever handle 103, and a drive bar 142, which is described in detail below. At least partially within the main escutcheon 110 rests a gearbox 108. An actuator 106 protrudes from the gearbox 108 and into the mortise lockset and its rotation cams the deadbolt 107 into or out of the doorframe (not shown). In FIG. 1, a deadbolt 107 is shown in the extended position. It should be noted that although the figures depict each piece having a certain shape, the embodiments are not limited to the shape and arrangements depicted. Other rotating arrangements including knobs, rods, or any suitable arrangement for a user to produce rotation motion are contemplated for operation of the mortise lockset 104. Furthermore, other locksets in place of the mortise lockset are also contemplated.

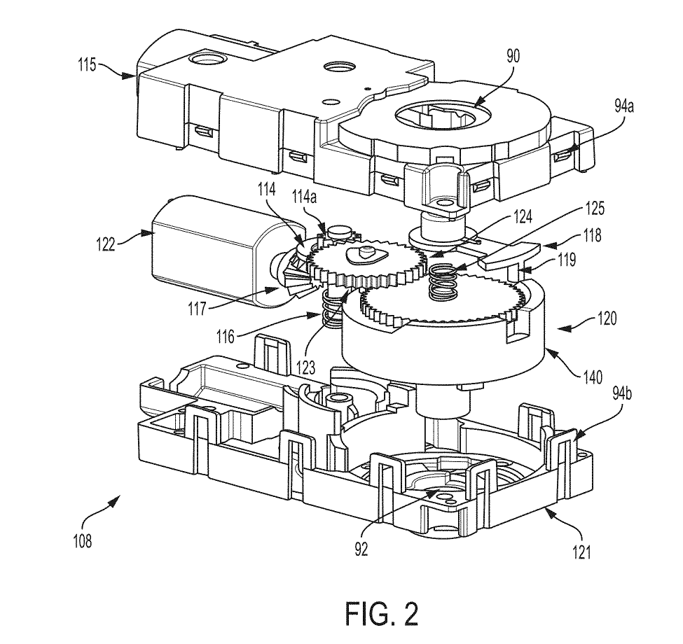

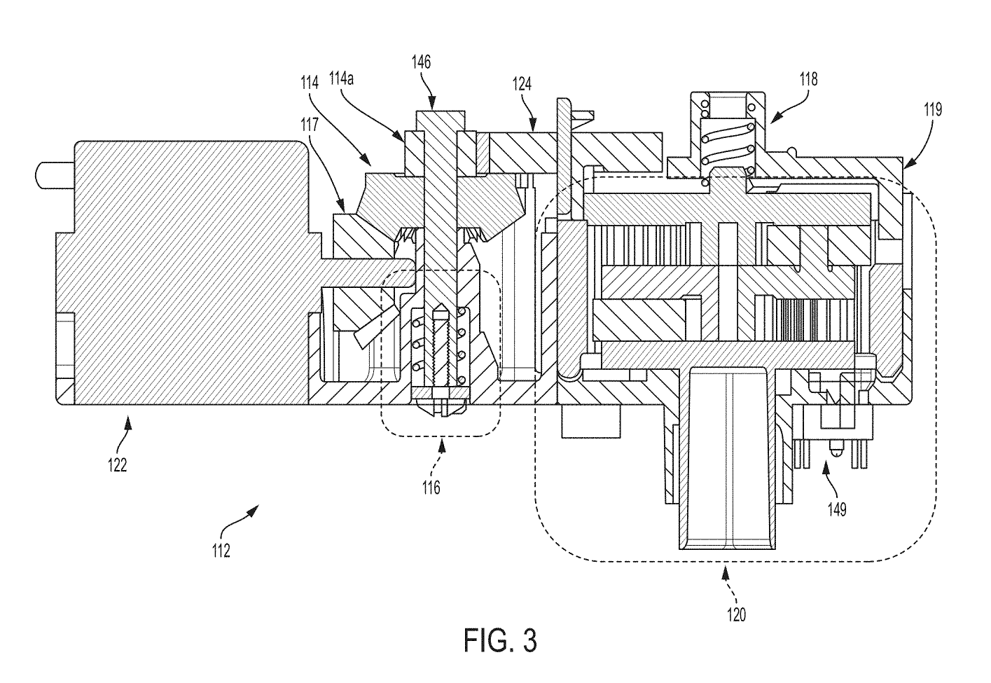

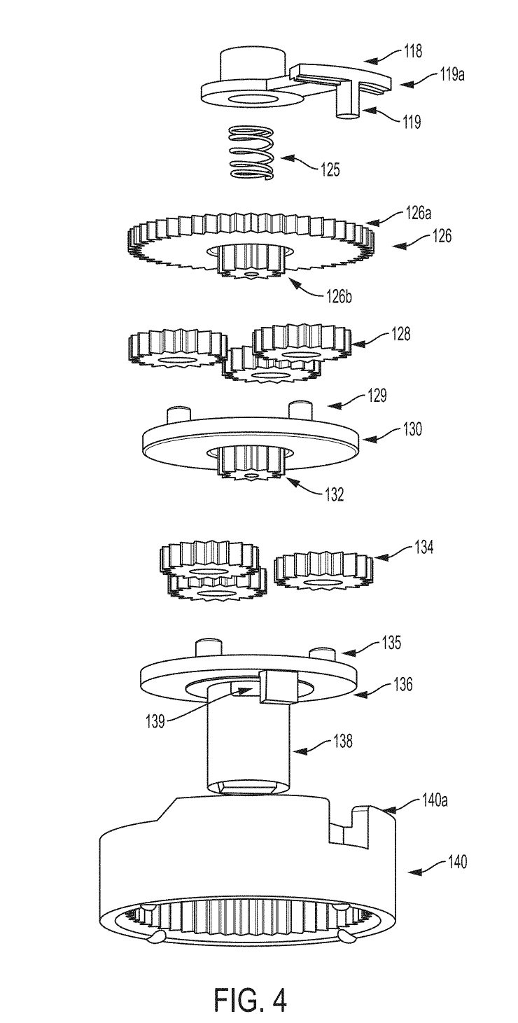

As illustrated in FIGS. 2 and 3, the gearbox 108 includes an upper housing 115 and a lower housing 121, which snap together at snap junctions 94a and 94b located at the edges of the housing. Within the housing, the gearbox also includes a motor 122, a first gear stage 114, a second gear stage 114, a planetary gear set 120, and a clutch 118. The housing is configured to encompass the motor, gear shafts, and planetary gear system within corresponding shaped alcoves. The upper housing 115 includes a drive bar aperture 90, through which the drive bar 142 makes contact with the clutch 118. The lower housing 121 includes an output shaft aperture 92, through which an output shaft 138 (FIG. 4) of the planetary gear set extends to connect to the actuator 106.

The stages of deadbolt actuation prior to the planetary gear system involve the motor 122 and the first and second gear stages 114, 124. Referring still to FIGS. 2 and 3, the motor 122 rotates a motor bevel pinion 117, which is coupled to the output shaft of the motor. The bevel pinion 117 in turn rotates a first stage bevel gear of the first stage gear stage 114. As the first stage bevel gear 114 rotates, a second gear 114a of smaller radius on the same shaft is rotated at the same rotational speed and drives the second stage gear 124. The second stage gear 124 includes a lower gear portion 123 which meshes with the planetary gear set 120, specifically a gear 126a as will be discussed below. While this specific gear arrangement is depicted in the figures, any suitable gear train may be employed to drive the planetary gear set using a suitable motor as should be appreciated by one of skill in the art.

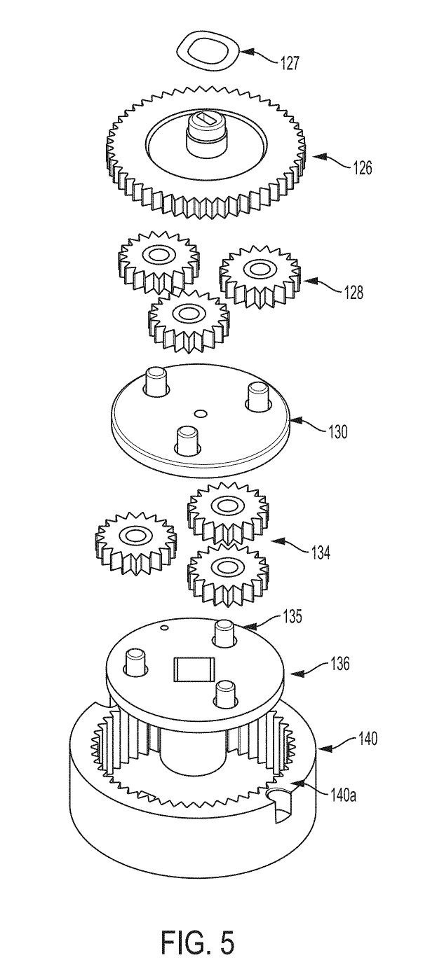

Moving to the latter stages of the gear train, the planetary gear set 120 is shown in detail in FIGS. 4 and 5. As illustrated, a first stage sun gear 126 is the top most gear of the set and its upper teeth 126a receive rotary input from the second stage gear 124, specifically the lower gear portion 123. The lower teeth of a first sun gear 126b meshes with first stage planet gears 128, which are substantially evenly spaced around the lower teeth of first stage sun gear 126b. Shafts 129 for each of the first stage planet gears 128 connect to a first carrier 130, which is integral with a second stage sun gear 132 on the opposite side. Second stage planet gears 134 mesh with the second stage sun gear 132 and shafts 135 of the second stage planet gears 134 are connected to a second stage carrier 136. An output shaft 138 extends from the opposite side of the second stage carrier 136. A ring gear 140 surrounds the entire assembly such that the first and second stage planet gears 128, 134 mesh with and rotate within the ring gear. As the first and second stage sun gears 126, 132 rotate while the planet gears 128, 134 rotate around the sun gears, the ring gear 140 remains stationary. Without wishing to be bound by theory, input rotational speed from the second stage bevel gear 124 is decreased at each stage of the planetary gear set, while rotational torque is increased. Although depicted with three planet gears at each stage, it should be appreciated that any suitable number of planet gears can be used. In one embodiment, the planetary gear system achieves a rotation ratio of 1:26 from planetary gear input to output shaft, although other ratios are contemplated depending on the designed gear ratios. In addition, although the disclosed planetary gear embodiment includes two overall stages, other configurations with more or fewer stages are also contemplated.

Referring still to FIG. 4, at the end of the gear system, the output shaft 138 delivers the rotation output from the gear system and the motor to the actuator 106 (see FIG. 1), which cams the deadbolt 107 into and out of its open and locked positions. In one embodiment, the gear system is configured to produce an output torque of 6.6 in-lbs at the shaft, and a rotation ratio of 500:1 from the motor to the output shaft. Other embodiments are not limited as such and can yield different outputs and motor-to-final shaft rotation ratios.

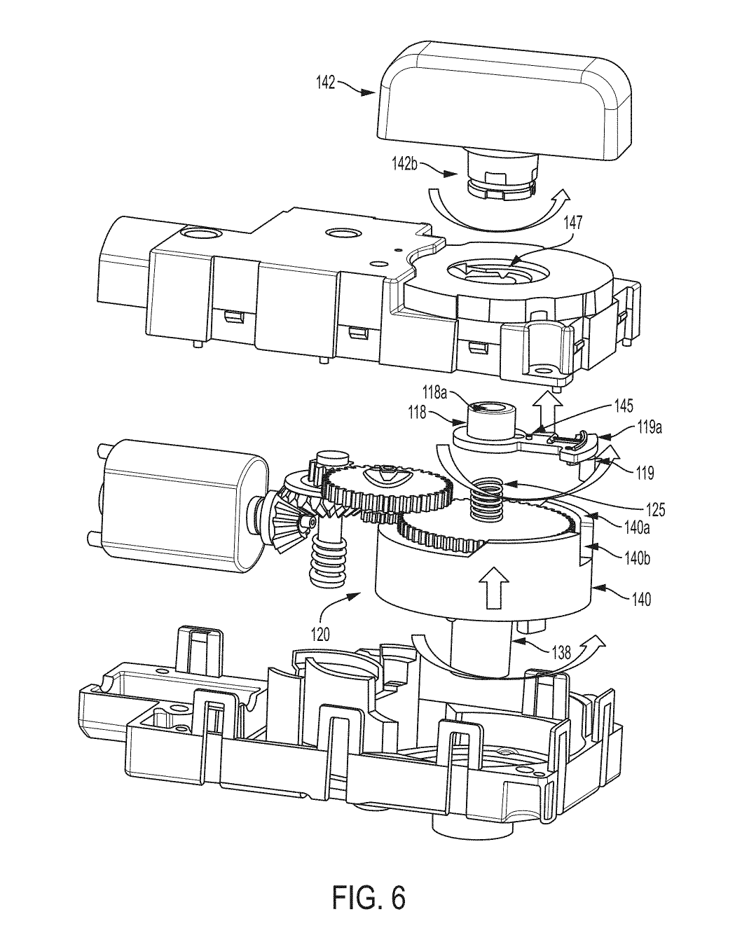

As noted above, in some embodiments it is desirable to manually actuate (e.g. unlock) the deadbolt 107 without having to turn the thumb drive multiple turns. Therefore, in some embodiments it is possible for a user to manually actuate the system independently of the first stage bevel gear 114 and the motor 122. In some embodiments, this may be accomplished through the use of a clutch. Referring again to FIGS. 2 and 3, a clutch 118 having a substantially keyhole shaped structure includes an upward facing extrusion at the top of the keyhole which accepts a drive bar 142b (FIG. 6), and a downwardly extending tab 119 at the periphery of the clutch. The clutch 118 rests on a spring 125 and a washer 127 atop the planetary gear set 120, with the downwardly extending tab 119 resting in a slot 140b (FIG. 6) within the ring gear 140 of the planetary gear set 120. The top of the clutch 118 protrudes through the upper housing 115 and interfaces with the thumb drive 142 as seen in FIG. 6. The use of the clutch 118 and its associated system is detailed below.

FIG. 6 depicts one embodiment of the thumb-turn direct drive system. As illustrated, the thumb drive 142 includes a shaped thumb drive shaft 142b that mates in and around a keyway 118a of the clutch 118 and, as such, connects through the outer housing directly to the clutch 118. Rotation of the thumb drive rotates the clutch, which then disengages the clutch 118 from the upper housing 115. The disengagement of the clutch releases the ring gear 140 from its detent recess, allowing the ring gear to rotate freely with the downwardly extending tab 119 of the clutch 118. The rotation of the ring gear 140 rotates the second stage planet gears 134 about the second stage sun gear 132, causing the second carrier 136 and the output shaft 138 to rotate, triggering the actuator 106 to move the deadbolt 107. The details of the mechanism are described in detail below. This arrangement bypasses portions of the gear train, accomplishing a ratio of 1:1 for thumb drive rotation to output shaft rotation.

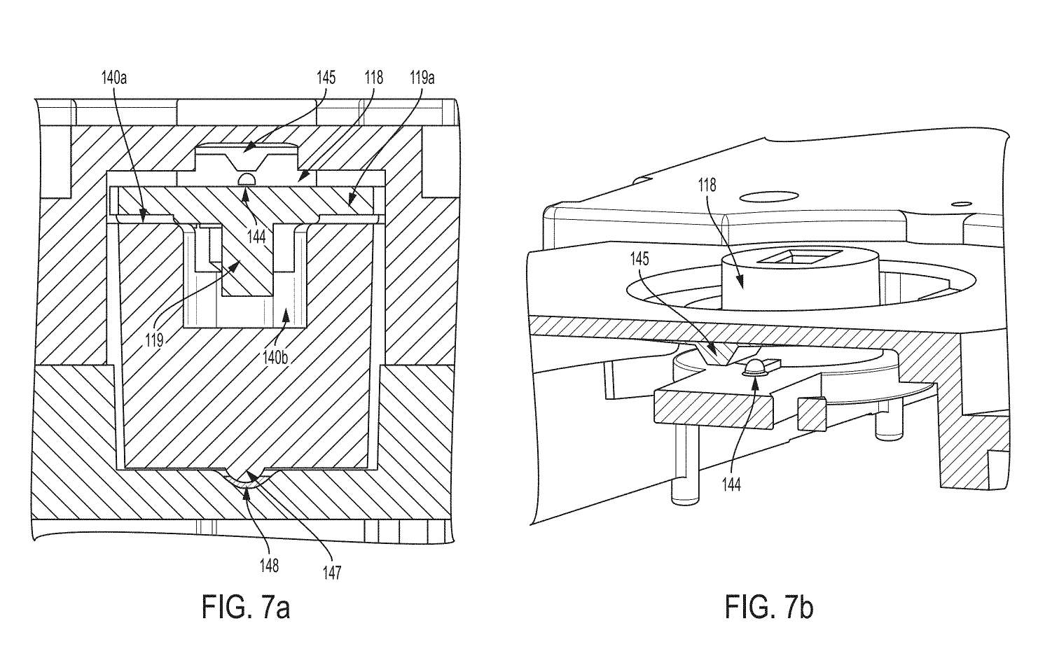

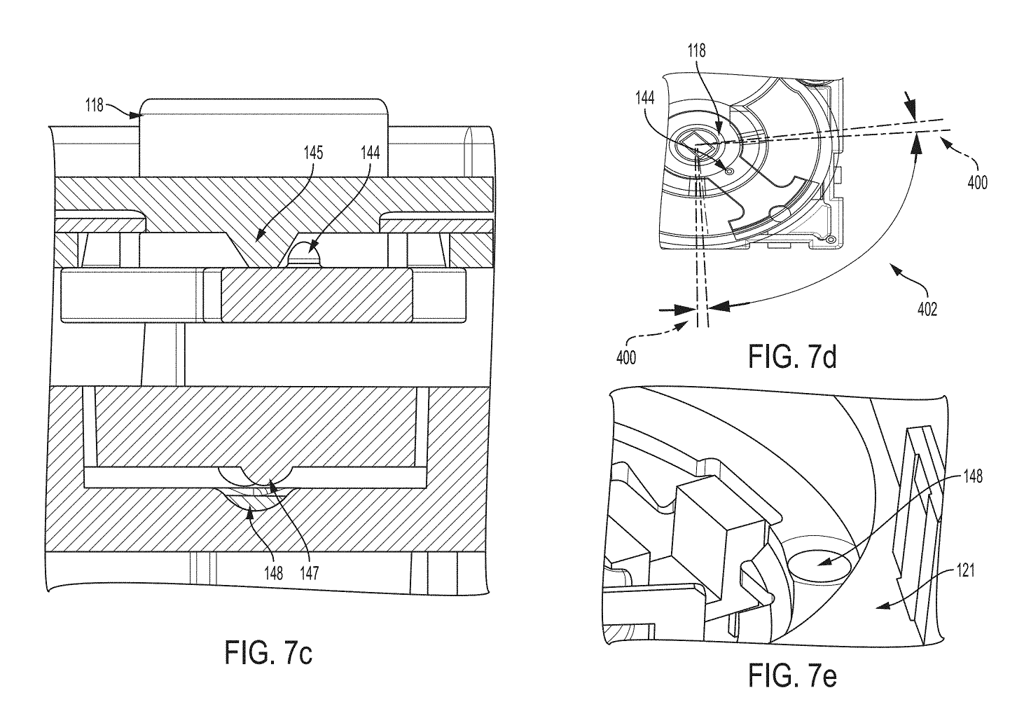

During normal operations when actuation is handled by the motor, as seen in partial section view of FIG. 7a, a ball 147 protruding from the ring gear 140 is set in a recess 148 of the lower housing 121 (shown without the ring gear in FIG. 7e), preventing rotation of the ring gear 140. The ball detent 147 remains in the recess because the clutch 118 presses down on the entire ring gear 140 via wings 119a on the clutch 118 pressing down on the upper surface 140a of the ring gear. The clutch 118 itself is being pressed down by triangular protrusion 145 of the upper housing 115 acting on top of a dimple 144 of the clutch 118. This in turn compresses a spring 125 underneath the clutch 118. When the thumb drive is rotated, as seen in FIGS. 7b and 7c, the clutch 118 is rotated, through the action of the thumb drive shaft 142b interfacing with the keyway 118a, thus moving the dimple 144 out from under the triangular protrusion 145. This removes the downward force on the clutch 118 and the downward force on the ring gear 140. Without a downward force, the spring 125 can slightly raise the clutch 118 due the spring's expansion. This in turn alleviates the downward force keeping the ball detent 147 in the recess, allowing the ring gear 140 to rotate. Thus, as the user continues to rotate the thumb drive as seen in FIG. 7d, the clutch continues to rotate, rotating the ring gear with it due to the downwardly extending tab 119 acting on the slot 140b of the ring gear 140. With the ring gear free to rotate, the second stage sun gear 132 remains stationary, preventing movement of any of the earlier gear stages. With the ring gear now being able to rotate, the ring gear causes the planet gears to also rotate and drive the second carrier 136. Because the carrier plate 136 is directly coupled to the shaft 138, the shaft rotates at a 1:1 ratio with the rotating ring gear.

When the thumb drive is rotated a quarter turn, the clutch encounters another set of triangular protrusions and recesses. The dimple 144 is slid under the next triangular protrusion, giving the user slight resistance. The clutch 118 is once again pressed down by the upper housing 115, pressing the ring gear 140 down into the next ball detent, once again locking the ring gear 140 in place, allowing motor operation to once again function as normal and rotate the planetary gear system relative to the ring gear 140 if activated. In this embodiment, four triangular protrusion and ball detent pairs are spread substantially evenly around the 360 degree radius at which the clutch 118 can potentially be. Such a configuration ensures that the user does not have to reset the clutch location after each manual actuation in case the motor alters the deadbolt state between manual actuations. Other embodiments have only three pairs of triangular protrusions and ball detents spaced substantially between 80 to 100 degrees apart and could require the user to reset the clutch back to its starting position if manual actuation of the deadbolt 107 is performed. Other suitable spacing and numbers of pairs exist in other embodiments including a spacing between 0-360 degrees apart for each pair, and potentially as few as one pair for full 360-degree rotations per deadbolt movement or many pairs for shorter rotation per deadbolt movement.

As seen in FIGS. 2, 4, and 5, the second stage carrier 136 includes a downwardly extending protrusion that contains a magnet 139. One or more magnetic position sensors 149 seen in FIG. 3 located under the planetary gear-set 120 detects the location of this magnet and therefore the rotational state of the second stage carrier 136. This allows the system to determine if the clutch 118 is in an engaged position or not, allowing a form of warning to be given to a user if they attempt to activate the motor when the motor is disengaged. The warning could be an auditory cue, a pop-up warning on the controller of the device, a warning light, or any other suitable stimulus. In other embodiments, motor activation is prevented entirely when the clutch is detected to be out of the engaged position, and the user is prompted to rotate thumb drive 142 until the clutch 118 is reengaged. In still other embodiments, there are multiple magnets of differing strengths extending from the second stage carrier 136 to precisely report the rotational state of the second stage carrier 136. In still other embodiments, the protrusions do not contain magnets, and an infrared position center detects if a protrusion is above it or not, determining if the clutch is engaged. Other possible sensors are also contemplated, including, but not limited to, vibration sensors, capacitive transducers, ultrasonic sensors, or any other suitable presence or position sensor.

Some embodiments may include a controller that receives input from magnetic position sensors 149. A battery powers the controller in this embodiment, but some embodiments allow the entire lock assembly to be powered directly by the home power grid. The controller also operates the motor in response to an activation signal received from a smartphone, triggered by a user via an application. In other embodiments, the activation signal could also come from a dedicated remote controller, or from the pressing of a button mounted on the door lock assembly or through a web application or directly from a computer. Upon receiving the activation signal, the controller runs the motor for a predetermined length of time to fully extend or retract the deadbolt. If the magnetic position sensors 149 report that the clutch is disengaged, the controller does not operate the motor and instead alerts the user to engage the clutch. As can be appreciated, the controller cooperates with a radio and suitable antenna and is able to wirelessly communicate with its remote actuation device via known protocols.

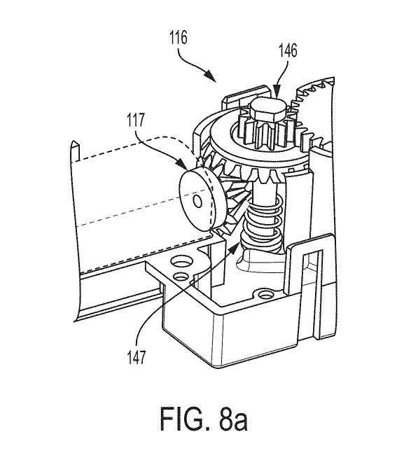

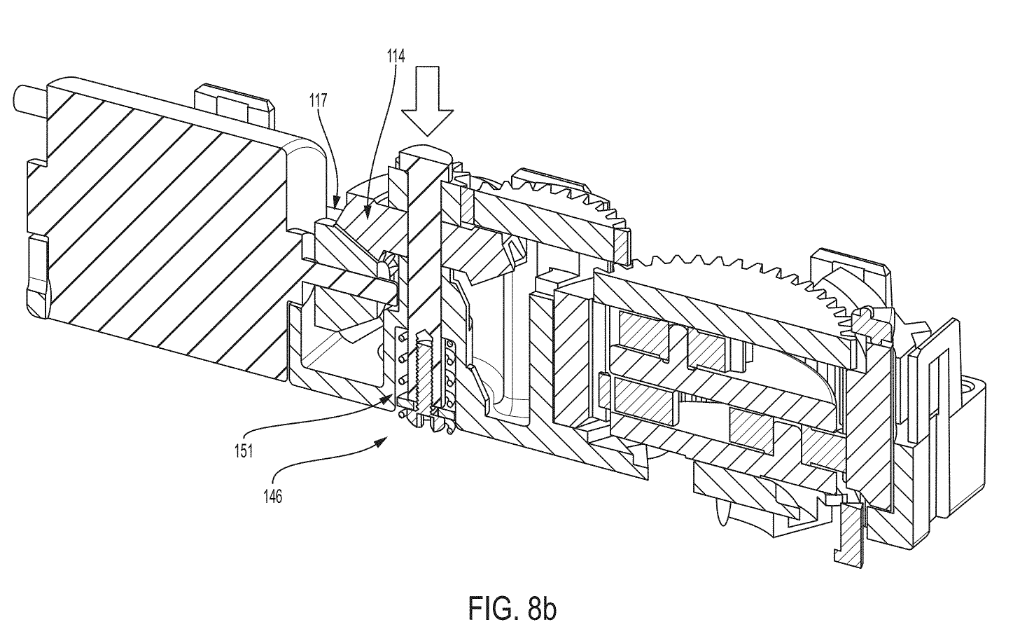

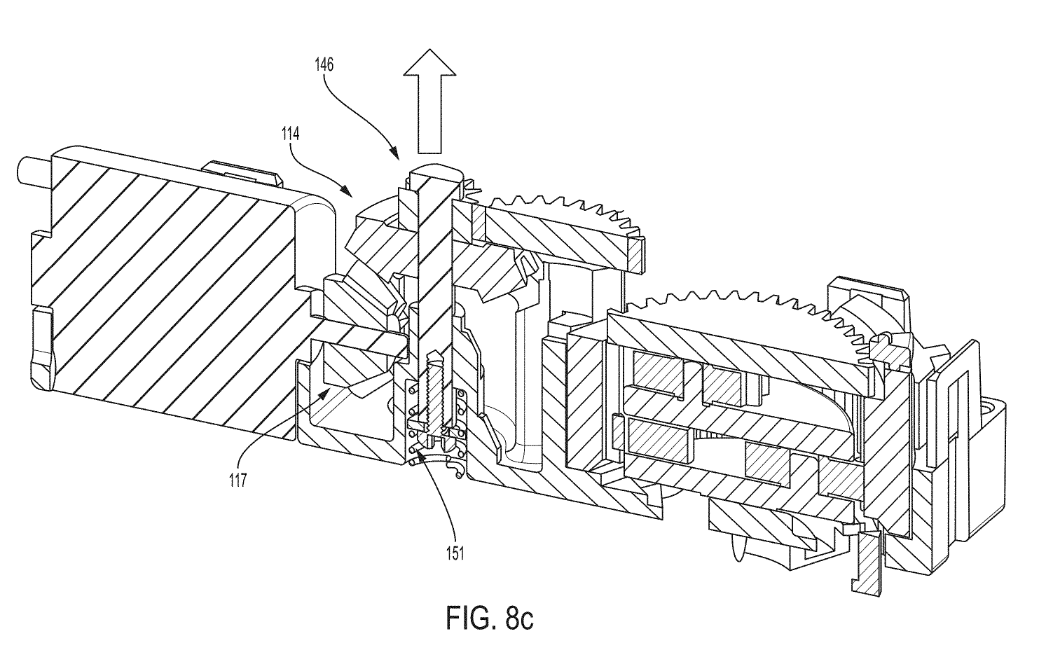

As described above, it may be desirable to include safeguards against damage to the motor and gear system in the event of a jam or other similar malfunctions. FIG. 8a-8c show an overload protection system integrated into the gear system in some embodiments. The overload protection system includes a shaft 146, which rests substantially on an overload spring 147, and the first stage bevel gears including the motor bevel pinion 117. In these embodiments, the shaft 146 of the first stage bevel gear 114 is a spring loaded pin. As can be seen in FIG. 8b, the spring 151 of the shaft 146 is constrained by the lower housing 121 (although it could be constrained to the shaft via a retaining ring or washer), thus actively keeping the shaft in its lowered operational state. As the motor bevel pinion 117 rotates, it imparts both a rotational and an upward force on the first stage bevel gear 114. In the event that the resistance to deadbolt movement exceeds a threshold, that is, the deadbolt becomes blocked or a gear later in the line gets jammed, the first stage bevel gear 114 would become obstructed from continuing to rotate. When this occurs, the force of the motor bevel pinion 117 on the first stage bevel gear 114 applies an upward camming force to the bevel gear shaft 146, compressing the spring 151 against the top of its alcove in the lower housing 121 as seen in FIG. 8c. This allows the motor bevel pinion 117 and therefore the motor to continue spinning unhindered by the jammed gear system, preventing damage to the motor or the gear system. While the gear train remains jammed, whenever the spring 151 decompresses and lowers the first stage bevel gear 114, it is again pushed back up by motor bevel pinion 117. If the jam or obstruction becomes cleared, the first stage bevel gear 114 returns to being free to spin, meaning it no longer remains continuously propped up by the rotation of motor bevel pinion 117. This allows the shaft 146 to be lowered as the spring 151 decompresses, i.e., moves the shaft downward. The first stage bevel gear 114 thus returns to meshed operations with the motor bevel pinion 117 when the resistance to deadbolt movement is below the threshold. The threshold can be predetermined and set by the biasing force of the spring. That is, the stronger the spring force, the higher the threshold. Accordingly, the spring load is sized according to the desired amount of resistance of deadbolt movement whereby exceeding that resistance would damage or otherwise prematurely reduce the life of the motor.

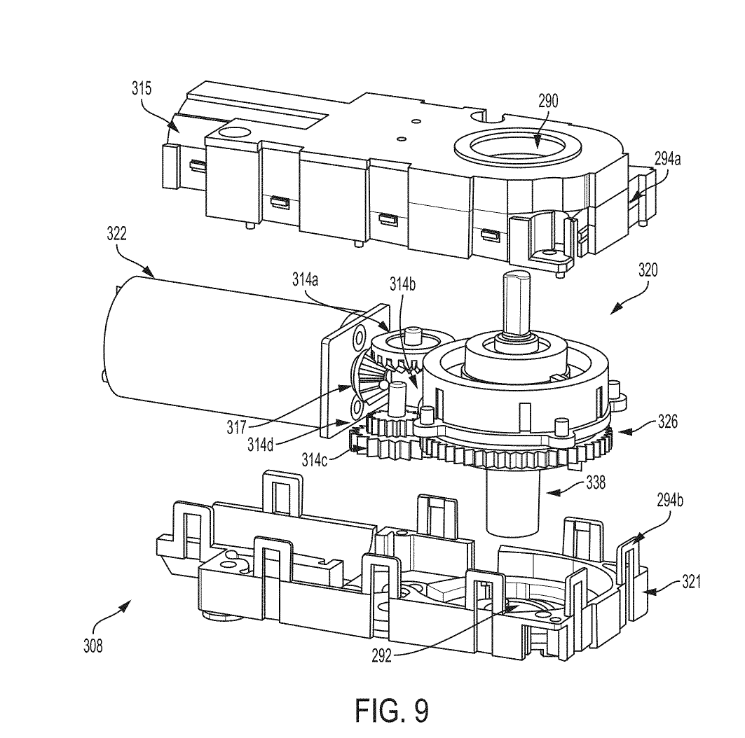

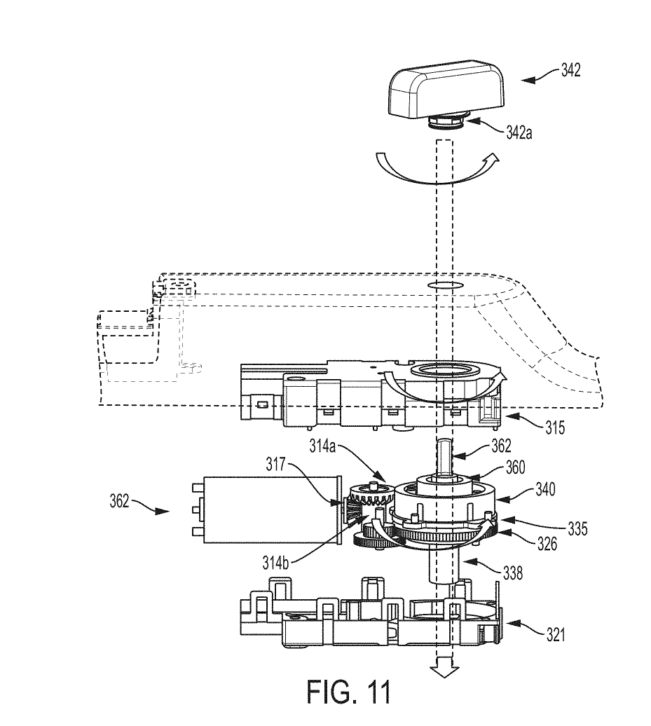

FIG. 9 shows another embodiment of a gearbox and the components within. The gearbox 308 includes an upper housing 315 and a lower housing 321, which in one embodiment snap together at snap junctions 294a and 294b located at the edges of the housing. Within the housing sits a motor 322, a first gear stage 314a and 314b, a second gear stage 314c and 314d, and a planetary gear set 320. Of course, the motor and/or other components need not be housed within the housing. In the depicted embodiment, the housing is designed to house the motor, gear shafts, and planetary gear system within corresponding shaped alcoves. The upper housing 315 includes a drive bar aperture 290, through which the thumb drive 342 (FIG. 11) makes contact and engages with a shaft 362. The lower housing 321 includes an actuator adaptor aperture 292, through which the output shaft of an actuator adaptor 338 of the planetary gear set extends to connect to the actuator 106. In one embodiment, the motor 322 is a neodymium motor, but the disclosure is not so limited and the motor 322 could be any motor suited to driving a deadbolt.

In this embodiment, the stages of deadbolt actuation prior to the planetary gear system involve the motor and the first two bevel gear stages. Referring still to FIG. 9, the motor 322 rotates the motor bevel pinion 317, which is coupled to the output shaft of the motor. The bevel pinion 317 in turn rotates the first stage bevel gear 314a. As the first stage bevel gear 314a rotates, the gear shaft 314b rotates at the same rotational speed and drives the second stage gears. The second stage gears include a lower gear portion 314c that meshes with the gear shaft 314b continuing the gear train, and a smaller gear 314d on the same shaft that meshes with the drive gear 326 of the planetary gear set, as will be discussed below. While this specific gear arrangement is depicted in the figures, any suitable gear train configured to drive the planetary gear set using a suitable motor may be employed.

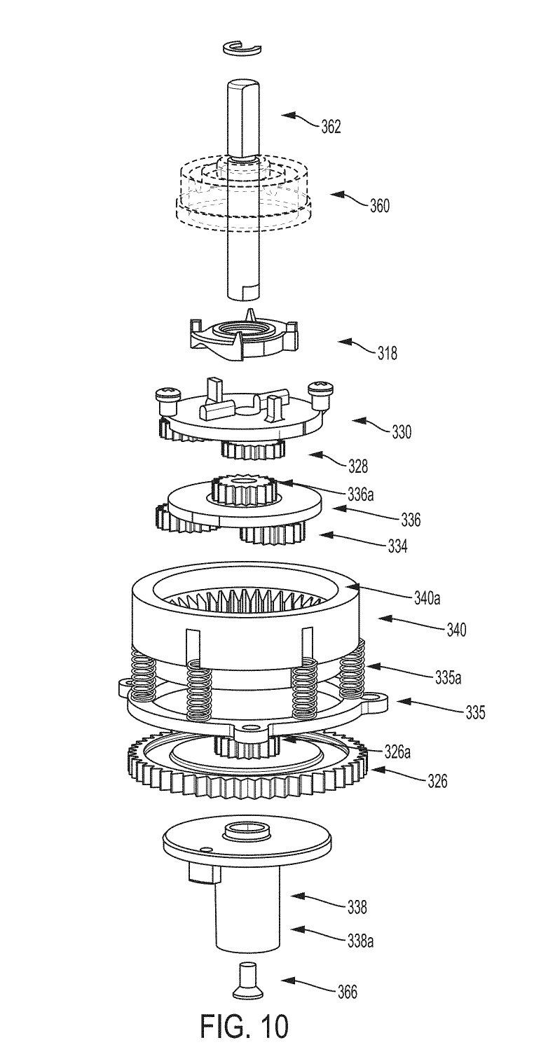

FIG. 10 shows the embodiment of a planetary gear set employed within the gearbox 308. As described above, the drive gear 326 receives rotary input from the motor 322 via the first and second gear stages. As the drive gear 326 rotates, a first stage sun gear 326a attached directly to the drive gear 326 drives the rotation of first stage planetary gears 334 within a ring gear 340. The ring gear 340 has a top surface 340a which abuts against the top housing 315, and it rests on a holder 335. Springs 335a extend from the holder 335 into notches along the gear, and the holder 335 remains stationary with the ring gear 340 during normal operations as the planetary gears rotate within. First stage planetary gears 334 are attached to and rotate with a first stage carrier 336, which in turn is continuous with a second stage sun gear 336a. That is, the second stage sun gear 336a is fixed to the carrier 336. As the second stage sun gear 336a rotates with the first stage carrier 336, it drives second stage planetary gears 328, which in turn drives a second stage carrier 330. Resting on and rotating with the carrier 330 is a clutch disk 318 housed within a cap 360, which together form the clutch assembly of this embodiment as will described below. A shaft 362 runs through the center of all the aforementioned planetary gear stages and acts as their axis of rotation, but is only directly coupled to the cap 360 and rotates as the cap 360 rotates. As the shaft 362 rotates, it rotates the actuator adaptor 338 which is anchored on the pin 336. The rotation of the actuator adaptor 338 causes the actuator 106 to drive the deadbolt.

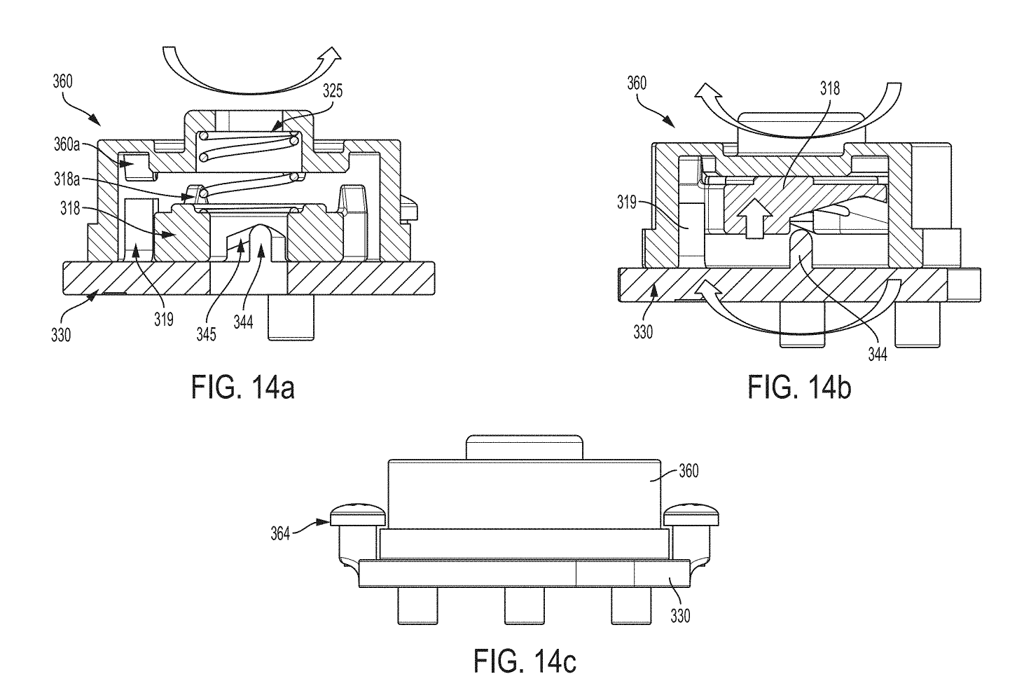

FIGS. 11, 12, 13, and 14a-14c illustrate the thumb-turn direct drive operations and clutch assembly of the gearbox 308. A thumb drive 342 may include a shaped thumb drive shaft 342a that mates with the shaft 362 and as such connects through the outer housing directly to the actuator adaptor 338 and the cap 360. When the thumb drive is rotated by a user, the shaft is rotated, rotating both the cap 360 and the actuator adaptor 338, actuating the deadbolt. The remainder of the gear system is not active because a spring 325 actively biases the clutch disk 318 downwards, keeping it disconnected from the cap 360. Because a raised edge 318a does not contact triangular protrusions 360a on the underside of the cap 360, the cap does not engage with the clutch 318 and thus the thumb drive is able to directly drive the actuator adaptor 338 and the cap is free to rotate with activating the gear system through the clutch. As also seen in FIG. 14a, the cap 360 rests on, but does not rotate with, the second stage carrier 330 during direct drive operation due to the action of the spring 325.

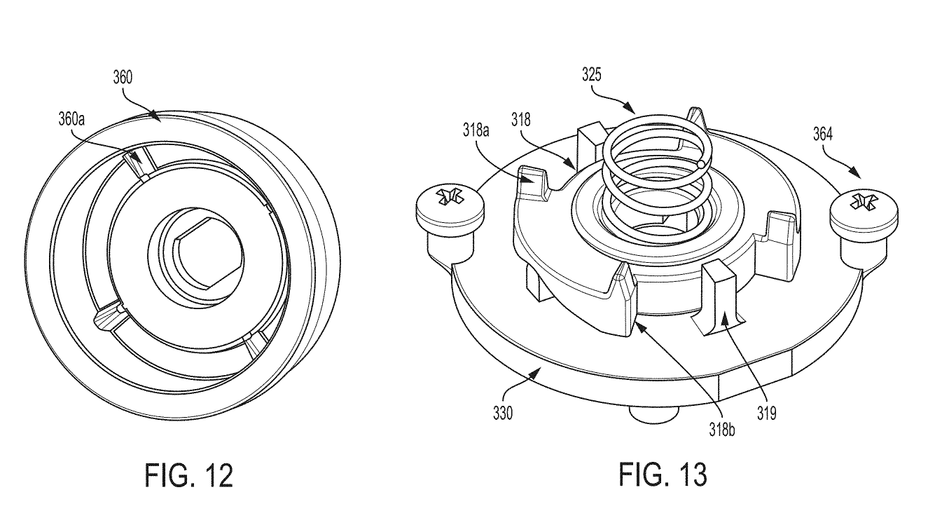

When the motor is activated, the rotations pass through the gear system, eventually causing rotation of the second stage carrier 330. As seen in FIG. 14b, as the second stage carrier 330 rotates, so do tall and short protrusions 319 and 344 respectively. Referring also to FIG. 13, as the second stage carrier rotates, a tall protrusion 319 makes contact with the clutch disk wall 318b, and a short protrusion 344 slides down a ramp 345 producing an upward force on the clutch disk 318. Thus, the clutch disk 318 rises up, overcoming the bias of the spring 325, and begins to rotate as the tall protrusion 319 begins pushing on the clutch disk wall 318b. As seen clearly in FIGS. 12 and 13, the cap 360 includes triangular protrusions 360a on its underside that correspond to raised edges 318a on the clutch disk 318. As the clutch disk rises up, the raised edges 318a come into contact with triangular protrusions 360a, and begin causing the rotation of the cap 360 and therefore the shaft 362. As seen in FIG. 14c, screws 364 serve as a hard stop to prevent the cap 360 from rising excessively. Thus, the rotation of the motor 322 works through the gear system and activates the clutch assembly in order to rotate the actuator adaptor. In contrast, when the thumb drive is rotated, the clutch assembly is not activated, disconnecting the planetary gear system from the shaft, allowing the rotation of the thumb drive 342 to directly rotate the shaft 362 and the actuator adaptor 338 without driving the remainder of the gear system. This both allows the rotation of the thumb drive 342 to translate to a 1:1 rotation ratio to the actuator adaptor 338, and further prevents rotation of the output shaft of the unpowered motor, preventing excessive back-drive force to the gear train and the motor.

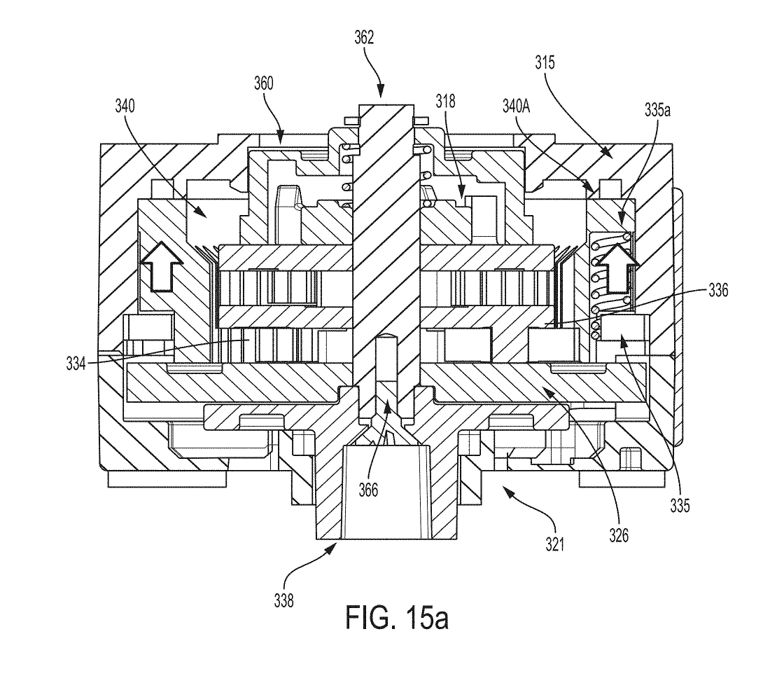

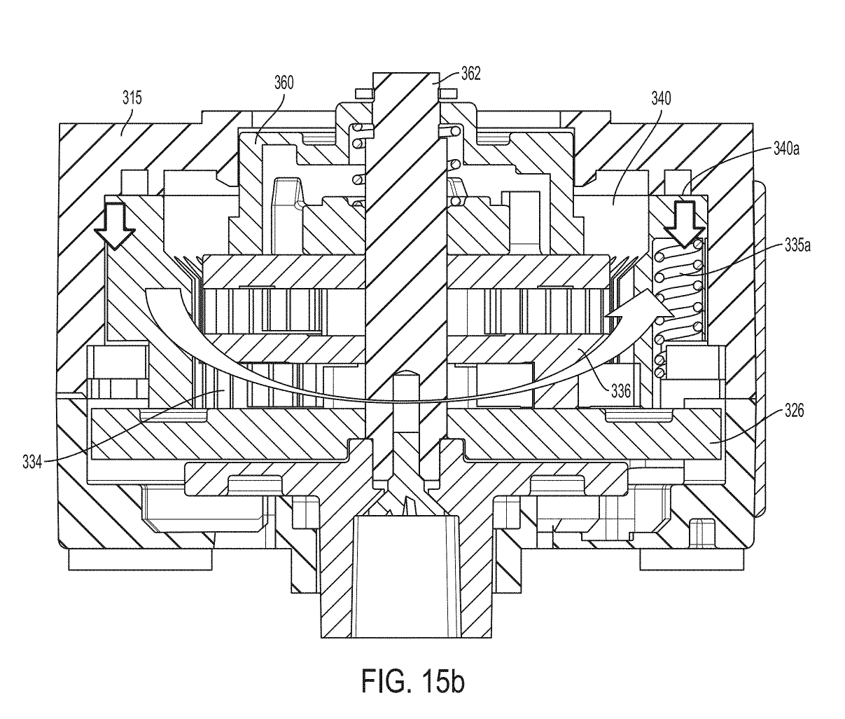

As discussed above, the gearbox may include an overload protection arrangement. FIGS. 15a and 15b show another embodiment of an overload protection system. FIG. 15a shows the planetary gear system of FIG. 10 during normal operations. As the drive gear 326 rotates, the rest of the planetary gear system and then eventually the cap 360 and the shaft 362 are rotated normally. The top surface 340a of the ring gear 340 is biased upwards by springs 335a and as such the top surface 340a abuts against the top housing 315, causing enough friction to prevent the ring gear 340 from rotating. In the event of the deadbolt becoming jammed or otherwise unable to move, the actuator adaptor 338 becomes unable to rotate. Despite the jam, the motor 322 continues to rotate, driving the planetary gear system within. With the jammed shaft, the first stage planetary gears 334 are no longer able to rotate the first stage carrier 336 and the rotational reaction force on the ring gear is increased. The increased force is enough to overcome the friction of the top surface 340a of the ring gear 340 abutting against the top housing 315, causing the ring gear to rotate with the first stage planetary gears 334, and the remainder of the gear system leading back to the motor. Allowing the ring gear to rotate will prevent power from being transmitted to the shaft. Thus, the motor continues to run freely and is not damaged by attempting to drive the jammed shaft. If the shaft becomes unjammed, the first stage carrier 336 is again free to rotate, and the reaction force on the ring gear 340 is decreased, preventing it from overcoming the friction force created by the spring bias pushing the top surface of the ring gear against the housing thus returning the gearbox to normal operations.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A deadbolt lock assembly, comprising:
a gear train including a planetary gear set; and
a deadbolt operatively coupled to the planetary gear set, wherein the planetary gear set is configured to move the deadbolt in response to actuation of the planetary gear set.

2. (canceled)

3. The deadbolt lock assembly of claim 1, wherein gear train is constructed and arranged to apply about 6.6 in-lbs of output torque on the deadbolt.

4. The deadbolt lock assembly of claim 1, wherein the planetary gear set includes a two-stage planetary gear set.

5. The deadbolt lock assembly of claim 4, wherein the two-stage planetary gear set Includes a first planetary gear set and a second planetary gear set, wherein the first planetary gear set includes a first sun gear, a first set of planetary gears operatively coupled to the first sun gear, a first carrier operatively coupled to the first set of planetary gears, and a ring gear directly operatively coupled to the first set of planetary gears, wherein the second planetary gear set includes a second sun gear fixedly attached to and rotatable with the first carrier, a second set of planetary gears operatively coupled to the second sun gear, a second carrier operatively coupled to the second set of planetary gears, and wherein the ring gear is directly operatively coupled to the second set of planetary gears such that the first and second planetary gear sets cooperate with the ring gear.

6. The deadbolt lock assembly of claim 5, wherein the first sun gear includes upper gear teeth and lower gear teeth, the upper gear teeth configured to be driven by an input and the lower gear teeth configured to drive the first set of planetary gears.

7. The deadbolt lock assembly of claim 5, wherein the second carrier includes an output shaft configured to drive the deadbolt.

8. (canceled)

9. The deadbolt lock assembly of claim 5, further comprising a housing configured to receive at least the ring gear, wherein the ring gear is selectively held to the housing to selectively prevent rotation of the ring gear relative to the housing.

10. The deadbolt lock assembly of claim 5, further comprising a hand operated drive actuator and a clutch coupled to the hand operated drive actuator, wherein the clutch is operatively coupled to the ring gear, wherein actuation of the hand operated drive actuator causes rotation of the ring gear.

11. The deadbolt lock assembly of claim 5, further comprising a motor operatively coupled to the first sun gear.

12. The deadbolt lock assembly of claim 6, further comprising a motor operatively coupled to the upper teeth of the first sun gear to provide the input to drive the first sun gear.

13. The deadbolt lock assembly of claim 1, further comprising:
a hand operated drive actuator operatively coupled to the deadbolt to move the deadbolt between an extended position and a retracted position; and
a clutch coupled to the hand operated drive actuator, wherein the clutch is operatively coupled to the planetary gear set so that actuation of the hand operated drive actuator causes the clutch to rotate a ring gear of the planetary gear set and moves the deadbolt.

14. (canceled)

15. (canceled)

16. The deadbolt lock assembly of claim 1, further comprising:
a motor operatively coupled to the gear train, wherein rotational output of the motor causes rotation of the gear train to move the deadbolt; and
an overload protection arrangement cooperating with the gear train, wherein the overload protection arrangement is configured to disengage at least a portion of the gear train from the motor when a resistance to deadbolt movement exceeds a predetermined threshold.

17. The deadbolt lock assembly of claim 1, further comprising:
a motor operated drive actuator operatively coupled to the deadbolt to move the deadbolt between an extended position and a retracted position; and
a clutch coupled to the motor operated drive actuator, wherein the clutch is operatively coupled to the planetary gear set, the clutch configured to connect the planetary gear set to the deadbolt in response to actuation of the motor operated drive actuator to move the deadbolt.

18. (canceled)

19. A deadbolt lock assembly, comprising:
a gear train including a planetary gear set, the planetary gear set including a ring gear;
a deadbolt operatively coupled to the planetary gear set, wherein actuation of the planetary gear set is configured to move the deadbolt in response to actuation of the planetary gear set;
a hand operated drive actuator operatively coupled to the deadbolt to move the deadbolt between an extended position and a retracted position; and
a clutch coupled to the hand operated drive actuator, wherein the clutch is operatively coupled to the ring gear, wherein actuation of the hand operated drive actuator causes the clutch to rotate the ring gear and move the deadbolt.

20. The deadbolt lock assembly of claim 19, wherein the clutch is configured to disengage portions of the planetary gear set to allow rotation of the ring gear.

21. The deadbolt lock assembly of claim 19, further comprising a housing configured to receive at least the ring gear, wherein the housing includes at least one recess and the ring gear includes at least one detent, wherein the detent is configured to nest within the recess to prevent rotation of the ring gear relative to the housing, the ring being rotatable relative to the housing when the detent is free from the recess.

22. The deadbolt lock assembly of claim 21, wherein the clutch includes a drive tab and the ring gear includes a slot configured to receive the drive tab, wherein actuation of the hand operated drive actuator causes the clutch to rotate and causes the tab to push on the ring gear to move the deadbolt.

23. The deadbolt lock assembly of claim 21, wherein the clutch includes a dimple and the housing includes a protrusion, wherein the protrusion is configured to push on the dimple to push the clutch on the ring gear to hold the detent of the ring gear within the recess of the housing.

24. The deadbolt lock assembly of claim 23, wherein the clutch is configured to move axially when the dimple becomes free of the protrusion upon rotation of the clutch by rotation of the hand operated actuator, wherein the ring gear is configured to move axially toward the clutch in response to axial movement of the clutch to free the detent of the ring gear from the recess of the housing and allow rotation of the ring gear.

25. The deadbolt lock assembly of claim 19, wherein the planetary gear set is operatively coupled to an output shaft, the gear train configured with a ratio of 1:1 for hand operated drive actuator rotation to output shaft rotation when rotating the clutch.

26. The deadbolt lock assembly of claim 19, wherein the planetary gear set includes a sun gear, a set of planetary gears operatively coupled to the sun gear, a carrier operatively coupled to the set of planetary gears, an output shaft coupled to the carrier, the deadbolt operatively coupled to the output shaft, and the ring gear being directly operatively coupled to the set of planetary gears, wherein rotation of the ring gear upon rotation of the clutch causes rotation of the carrier to rotate the output shaft and move the deadbolt.

27.-34. (canceled)

35. A deadbolt lock assembly, comprising:
a gear train;
a deadbolt operatively coupled to the gear train;
a motor operatively coupled to the gear train, wherein rotation of the motor causes rotation of the gear train to move the deadbolt; and
an overload protection arrangement cooperating with the gear train, the overload protection arrangement configured to decouple at least a portion of the gear train from the motor when a resistance to deadbolt movement exceeds a predetermined threshold.

36. The deadbolt lock assembly of claim 35, wherein the gear train includes a relief gear abutting against a housing causing friction and preventing rotation of the relief gear, wherein when the resistance to deadbolt movement exceeds the predetermined threshold, the relief gear overcomes the friction and rotates freely causing at least one gear of the gear train to become operatively disengaged from the motor.
